(19) United States
(12) Patent Application Publication
(10) Pub. No.: US 2002/0116177 A1
(43) Pub. Date: Aug. 22, 2002

(54) Robust perceptual speech processing system and method

(76) Inventors: Linkai Bu, Tainan (TW); Tzi-Dar Chiueh, Taipei (TW)

Correspondence Address: BAKER & McKENZIE, 12th Floor, 101 West Broadway, San Diego, CA, 92101, US

(21) Appl. No.: 09/904,221

(22) Filed: Jul. 12, 2001

(30) Foreign Application Priority Data
Jul. 13, 2000 (TW) 89114004

(51) Int. Cl. G10L 19/00

(52) U.S. Cl. 704/200.1

(57) ABSTRACT

An apparatus and method for the application of perceptual processing techniques to the speech Fourier spectrum to achieve a perceptual spectrum that is based upon human auditory perception embodied in a perceptual speech processor comprising a noise masker utilizing a masking winner-take-all circuit, a magnitude renormalizer for translating objective signal magnitude to a subjective loudness minimum audible field, and a mel-scale frequency adjuster for adjusting the physical Hertz frequency of a signal to the perceptual mel-scale frequency.

### FIELD OF THE INVENTION

This invention relates generally to automatic speech recognition systems and more particularly to a perceptual speech processing system for improving the robustness of automatic speech recognition systems.

### BACKGROUND OF THE INVENTION

Modern automatic speech recognition (ASR) systems have been in development for over 30 years and have achieved high recognition accuracy rates in laboratory and controlled settings. However, there remains a robustness problem related to adverse conditions in actual speaking environments which typically include background noise, speech distortion, and an individual's particular articulation characteristics. Background noise from people speaking and moving, appliances, machinery, traffic, etc. is present in almost any environment, be it the home, office, car, or in public places. Distortion of a speech spectrum can result from the frequency response, mounting position, and transducer quality of a microphone as well as from interference in a signal transmission line. Further, individual speakers each have their own unique articulation proclivities and even for the same speaker, speech variations can occur due to, among other things, the emotions of the moment (Lombard effect). Thus, an ASR system must be robust as to the speaking environment so that sufficiently high levels of accurate speech recognition may be achieved.

Conventional ASR systems have attempted to address the robustness problem by using reference patterns trained from speech with the same corrupting noise components, but this approach suffers from the inability to handle different adverse environment and is thus not practicable. Other methods to improve robustness include signal enhancement preprocessing by suppressing the noise before recognition processing; for example, adaptive noise cancellation using two signal sources. However, this approach requires that the noise component in the corrupted signal and the noise reference have a high coherence (for example, to suppress engine noise in a car, the microphones for the two signal sources cannot be separated by more than 5 cm, thus making it impossible to prevent speech itself to be included in the noise reference). Yet another approach is to use estimates of the noise characteristics, such as noise power and/or SNR and add it to a clean speech database to construct a function that maps a noisy spectral component to a noise-suppressed value (composite model spectrum). However, the method is limited by the requirement of a good assumption for the noise estimate (thereby reducing applicability to unpredicted noise environments) and high computational complexity.

Noise-canceling microphones (exposing both sides of the diaphragm to the sound field) and multisensor arrangements can increase SNR, but the microphones and sensors must be positioned precisely and the operating algorithms require specific adaptive training, thereby limiting their general use.

For broadband noise environments, lower level speech regions will be more affected by the noise. Noise masking via a filter-bank analyzer selects the masking noise level (for each channel output of the filter) as the greater of the noise level in the reference signal and that in the testing signal. That channel output is then replaced by the mask value if it is below the corresponding mask level, thereby preventing spurious distortion accumulation because those channels that are determined to have been corrupted by noise will have the same spectral value in the training and the testing tokens. However, when the two patterns being compared have very different noise levels, and the test pattern has a high level of noise, this method will result in all the reference patterns that are of lower level than the noise having equally small differences, thus making the comparison meaningless.

In contrast to pure machine speech recognition described above, speech perception by humans is relatively robust, achieving high recognition accuracy in adverse environments. For example, for an input SNR below 20 dB, the recognition accuracy of conventional ASR systems is significantly degraded whereas human beings easily recognize speech for signal quality as low as 0 dB SNR. Signal distortion, while annoying, seldom causes severe speech misrecognition by humans (unless the amplitude of the signal itself is too low) and individual speaker's articulation characteristics (at least for native speakers) do not cause significant perception problems. Thus, there have been attempts to develop speech recognition systems to mimic human speech perception. The approaches can be divided essentially into two types: The first models the functionality of a human's auditory system (for example, the basila membrane and cochlea), but the system is complicated by numerous feedback paths from the neural system and unknown interactions among auditory nuclei, making such attempts theoretically sound but practically limited. The second attempt utilizes artificial neural networks (ANN) to extract speech features, process dynamic and nonlinear speech signals, or combine with statistical recognizers. But ANN systems have the disadvantage of heavy computation requirements making large vocabulary systems impractical.

All ASR systems require the use of a spectral analysis model to parameterize the sound signal so that comparisons with reference spectral signals can be made for speech recognition. Linear predictive coding (LPC) performs spectral analysis on speech frames with a so-called all-pole modeling constraint. That is, a spectral representation typically given by Xₙ(eⁱ) is constrained to be of the form /A(eⁱ), where A(eⁱ) is a p^{th} order polynomial with z-transform given by

A(z)=1+a₁z⁻¹+a₂z⁻²+ . . . +aₚz^{-p}

The output of the LPC spectral analysis block is a vector of coefficients (LPC parameters) that parametrically specify the spectrum of an all-pole model that best matches the signal spectrum over the period of time of the speech sample frame. Conventional speech recognition systems typically utilize LPC with an all-pole modeling constraint. However, the pole position in an all-pole spectrum typically is affected through the appearance of noise in the valley sections which, if significant, severely degrades the robustness of the speech recognition.

### SUMMARY OF THE INVENTION

There is a need therefore for a robust speech recognition system capable of accurate recognition in adverse environments. The present invention is a the application of three perceptual processing techniques to the speech Fourier spectrum to achieve a perceptual spectrum that is based upon human auditory perception embodied in a perceptual speech processor comprising a noise masker utilizing a masking winner-take-all circuit, a magnitude renormalizer for translating objective signal magnitude to a subjective loudness minimum audible field, and a mel-scale frequency adjuster for adjusting the physical Hertz frequency of a signal to the perceptual mel-scale frequency.

### BRIEF DESCRIPTION OF THE DRAWINGS

FIG. 1 is a frequency domain graph showing the magnitude of a mask tone generated by a 1 kHz, 80 dB pure tone.

FIG. 2 is a time domain graph illustrating a mask tone and a masker generated by the masking tone.

FIG. 3 is a frequency domain graph of minimum audible field (MAF) and equal loudness curves.

FIG. 4 is a graph showing the relationship between frequency scale and mel-scale.

FIG. 5 is a flowchart showing the sequence and processing of the perceptual characteristics to produce a perceptual spectrum according to the present invention.

FIG. 6 (a) is the Fourier spectrum of the Mandarin vowel “i”, (b) shows the result of the masking effect, (c) shows the result of MAF processing, and (d) shows the result of mel-scale resampling according to the present invention.

FIG. 7 is a graph of an experiment measuring recognition rate against signal-to-noise (SNR) according to the present invention.

FIG. 8 illustrates an embodiment of a masking Winner-Take-All circuit 800 according to the present invention.

FIG. 9 is a graph illustrating piecewise linear resistors PWLₙ utilized to produce a current vs. differential voltage according to the present invention.

FIG. 10 is a graph of the current output of a masker according to the present invention.

FIG. 11 is a graph illustrating envelope extraction by plotting node voltages corresponding to different PWLs according to the present invention.

FIG. 12 is a conceptual schematic diagram of a single masking WTA cell according to an embodiment of the present invention.

### DETAILED DESCRIPTION OF THE INVENTION

Automatic speech recognition systems sample points for a discrete Fourier transform calculation of the amplitudes of the component waves of speech signal. The parameterization of speech waveforms generated by a microphone is based upon the fact that any wave can be represented by a combination of simple sine and cosine waves; the combination of waves being given most elegantly by the Inverse Fourier Transform:

g(t)=∫_{-∞}^{∞}G(t)e^{i2πft}dƒ

where the Fourier Coefficients are given by the Fourier Transform:

G(f)=∫_{-∞}^{∞}g(t)e^{-τ2πft}dt

which gives the relative strengths of the components (amplitudes) of the wave at a frequency f, the spectrum of the wave in frequency space. Since a vector also has components which can be represented by sine and cosine functions, a speech signal can also be described by a spectrum vector. For actual calculations, among other methods, a discrete Fourier transform may be used:

$$G ( \frac{n}{τ N} ) = {\sum }_{k = 0}^{N - 1} [ τ \cdot g ( k τ ) {e}^{- i2πk \frac{n}{N}} ]$$

where k is the placing order of each sample value taken, is the interval between values read, and N is the total number of values read (the sample size). Computational efficiency is achieved by utilizing the fast Fourier transform (FFT) which performs the discrete Fourier transform calculations using a series of shortcuts based on the circularity of trigonometric functions.

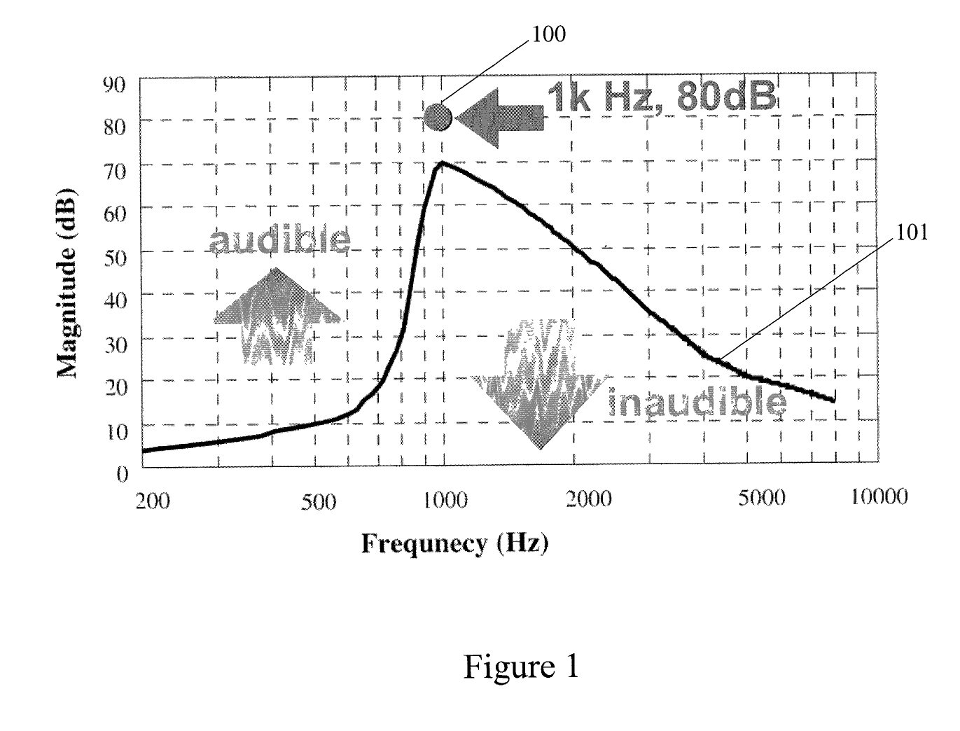

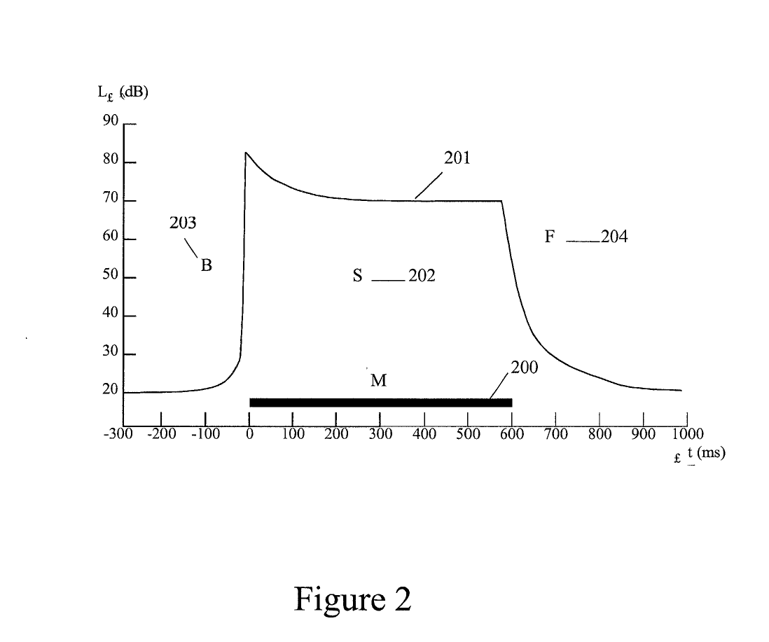

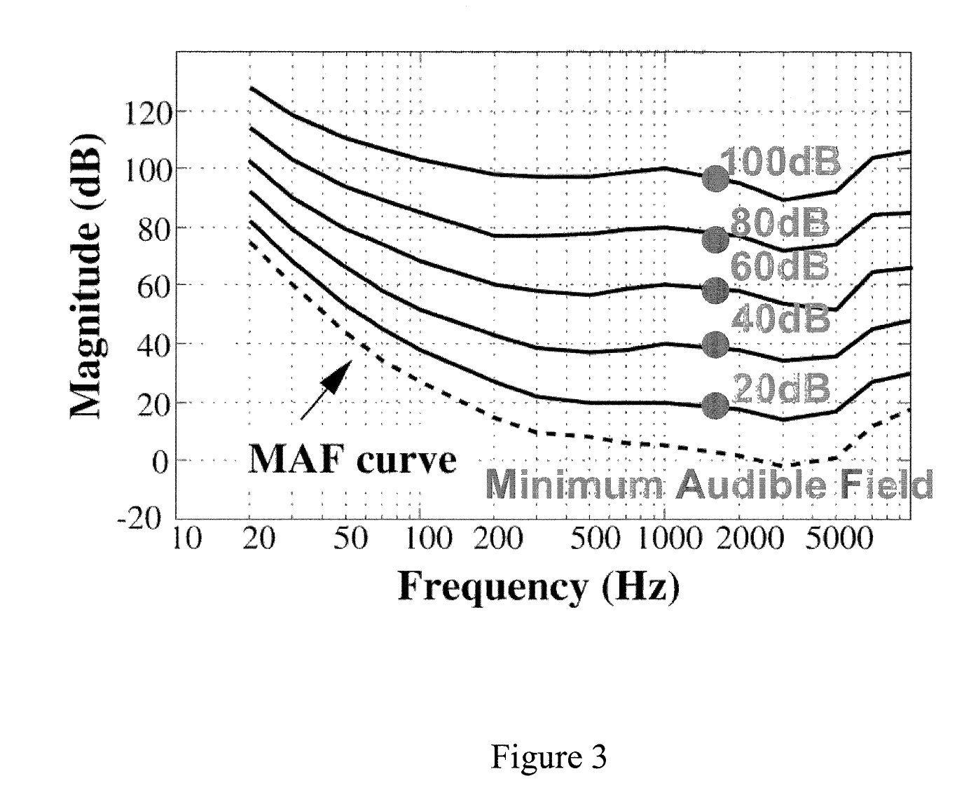

The masking effect is the observed phenomenon that certain sounds become inaudible when there are other louder sounds which are both temporally and spectrally proximate. The masking effect can be measured by experiments of subjective response. FIG. 1 is a frequency domain graph showing the magnitude of a mask tone (solid line 101) generated by a 1 kHz, 80 dB pure tone (small circle 100). Any signal below solid line 101 will be inaudible and if its frequency is proximate the mask tone, it moreover will be seriously inhibited, with the inhibition being greater towards the high frequencies. FIG. 2 is a time domain graph illustrating the mask tone as black bar 200 and the masker 201 generated by the masking tone. There is not only simultaneous masking at region 202, but also backward masking at 203 and forward masking at 204. It is known in the art that “loudness” depends not only on signal magnitude but also on frequency. FIG. 3 is a frequency domain graph of minimum audible field (MAF) below which sound signals are too weak to be perceived by humans (the dashed curve 300) and equal loudness curves 301, 302, 303, 304, and 305. To translate objective sound signal magnitude to human subjective loudness, the magnitude of a particular frequency component of the signal must be renornalized according to the MAF curve as follows:

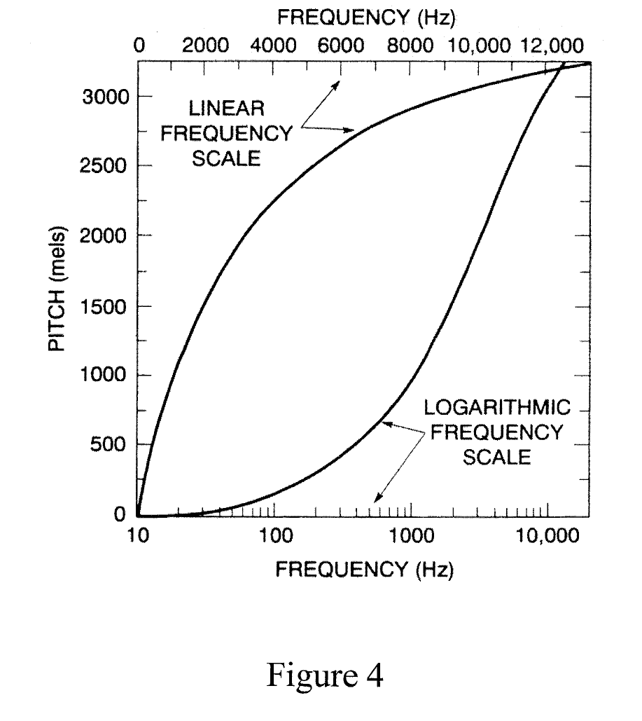

L(in dB)=M(in dB)−MAF

where L and M are the loudness and magnitude of a frequency component of the sound signal respectively, and MAF is the value of MAF at that frequency. In an embodiment of the present invention, the magnitude of a given frequency component is renormalized to all of the equal loudness curves 301, etc. To describe human subjective pitch sensation, the frequency scale is adjusted to a perceptual frequency scale termed the mel-scale. FIG. 4 is a graph showing the relationship between Hertz- (or frequency) scale and mel-scale given by:

mel=2595×log(1+f/700)

where ƒ is the signal frequency.

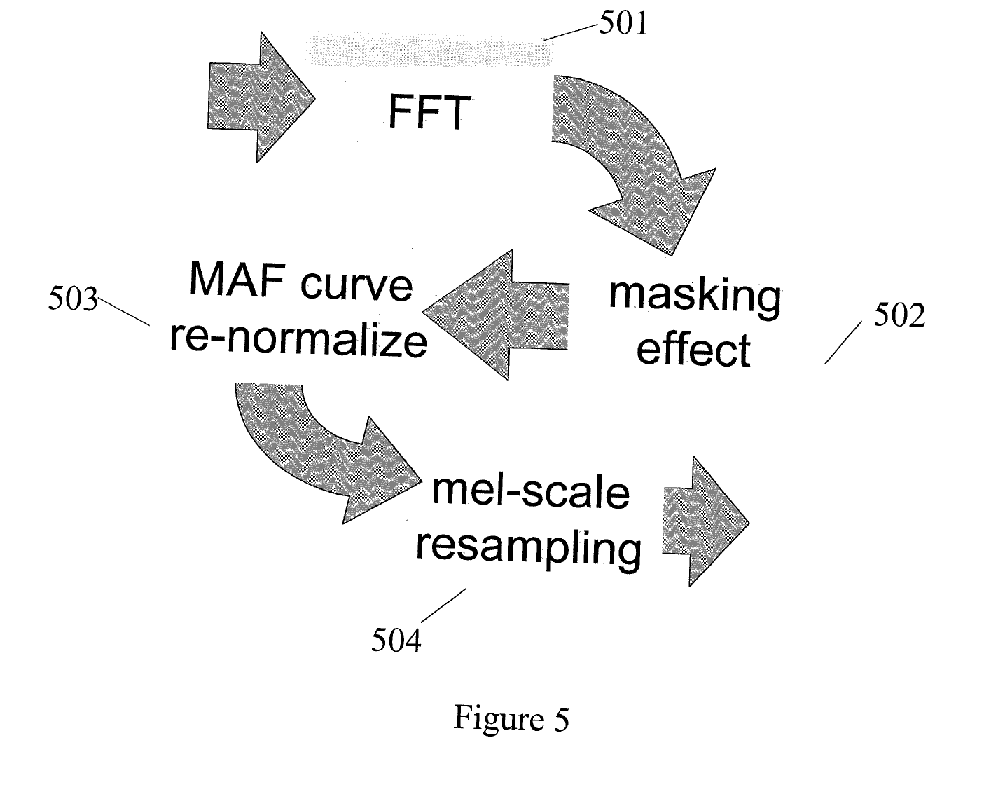

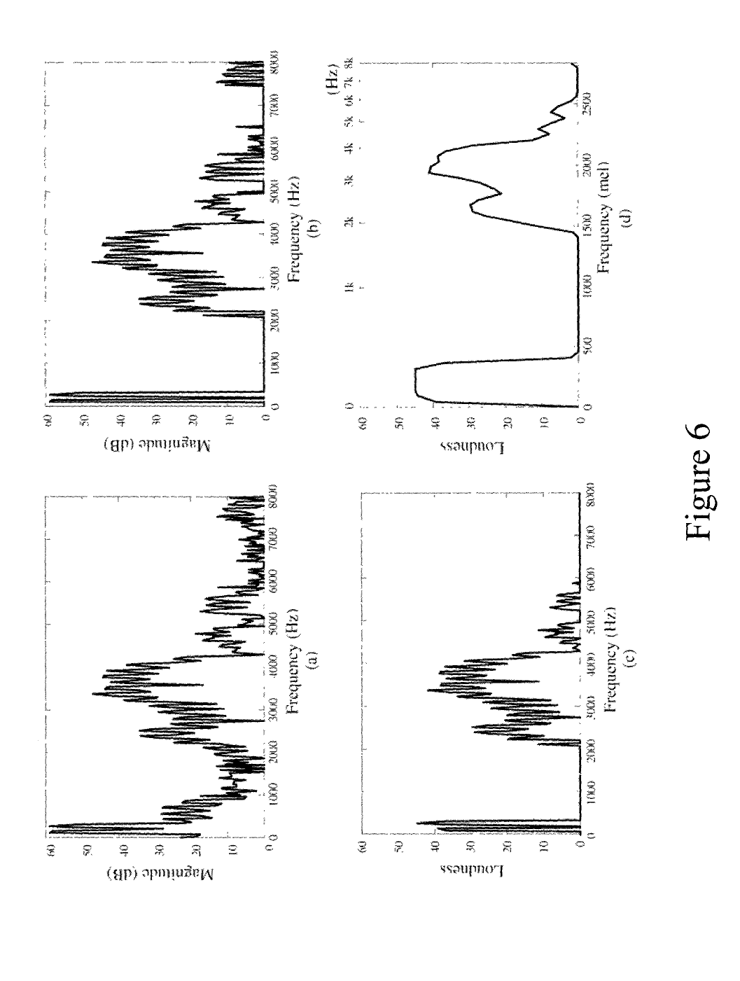

The sequence and processing of the perceptual characteristics described above to produce aperceptual spectrum in a preferred embodiment of the present invention is shown in the flowchart of FIG. 5. Step 501 is the FFT inputted into step 502 which removes all the frequency components of the sound signal that are shadowed by louder neighboring sounds according to the final masker in the previous and current frames of the sound signal. Step 503 is the renormalization of the magnitude of each frequency component of the sound signal according to the MAF curve and step 504 is the translation of the frequency components to mel-scale by resampling. This sequence of steps is arranged for computational efficiency and is not necessarily the same sequence as for an auditory pathway. It is understood by those in the art that any order of the steps 501, 502, 503, and 504 are within the contemplation of this invention. The results of steps 501, 502, 503, and 504 are shown in FIG. 6 wherein (a) is the Fourier spectrum of the Mandarin vowel “i”, (b) is the result of step 502 masking effect, (c) is the result of step 503 MAF processing, and (d) is the result of mel-scale resampling. FIG. 6(b) shows that the masking effect of the present invention eliminates most frequency components between 400 Hz and 2 kHz, greatly reducing the amount of information to be processed and removing significant background noise. FIG. 6(c) shows that low and high frequency components are considerably attenuated and FIG. 6(d) shows a perceptual spectrum of the exemplary vowel “i” according to the preferred embodiment of the present invention. In another embodiment, the low frequency components, where most vowel information is carried, are sampled more finely than for other frequencies. The final perceptual spectrum preserves only a spectral envelope as that can alone convey significant information concerning the shape of the vocal tract. Pitch information is also advantageously removed as it is not essential to vowel recognition. Step 502, the mask effect, is distinct from the conventional all-pole spectrum model. The all-pole model produces concave smoothed valleys in the spectrum, whereas the present invention generates sharp edges. When the spectrum is contaminated by noise, the pole position in an all-pole spectrum typically is affected through the appearance of noise in the valley sections. In the present invention, most valley noises are removed by the masker, thus achieving cleaner signals and enhanced robustness.

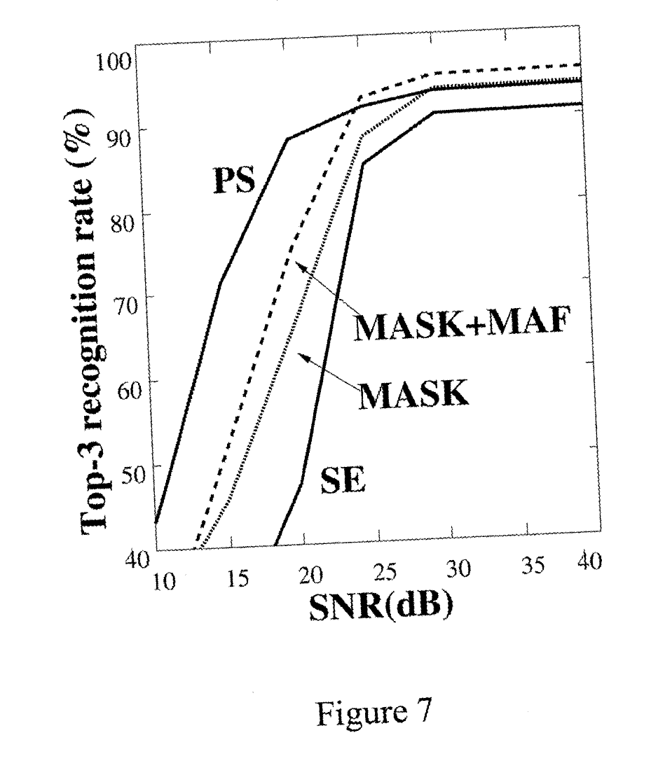

FIG. 7 is a graph of an experiment measuring recognition rate against signal-to-noise (SNR). The perceptual spectrum curve (PS) compared to an FFT Spectrum Envelope curve (SE) results in significantly lower SNR and higher recognition rates. The masking effect (MASK) and MAF renormalization and MASK by itself also significantly enhance recognition rates and reduce noise as compared to SE.

The masking effect is the phenomenon whereby weaker tones become inaudible when there is a temporally and spectrally adjacent louder tone present. It is known that auditory neurons are arranged in order of their respective resonant frequencies (the tonotopic organization), so inhibiting the perception of neighboring frequency components corresponds to the inhibition of lateral auditory neurons. The activity of a neuron depends on the neuron's input, as well as inhibition and excitation from neighbors. Neurons with stronger outputs will inhibit lateral neighbors via synaptic connections. Assuming a neuron i has the strongest input stimuli, neuron i will then inhibit its neighbors most as well as excite itself most. Because other neurons in the area are non-competitive (“muted”) with neuron i, only neuron i generates output. This surviving neuron i is the “winner” in the so-called Winner-Take-All (WTA) neural network which extends, reasonably, only to localized regions as the interactions become weaker for farther-away neurons. A “global” model of the WTA network is an electronic circuit having n neurons each represented by two nMOS transistors, all of which are coupled at a node. When an input stimuli is simulated using an electric current to the transistors in parallel, the voltage level of the node depends on the transistor (neuron) having the highest current input. In equilibrium, a bias current flows through the winner neuron effectively inhibiting the output currents of all the other neurons. By separating the transistors with resistors in series, and biasing each transistor, the circuit can be “localized”.

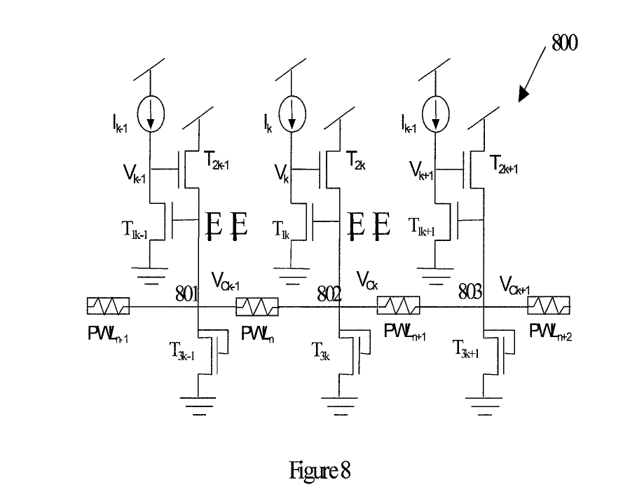

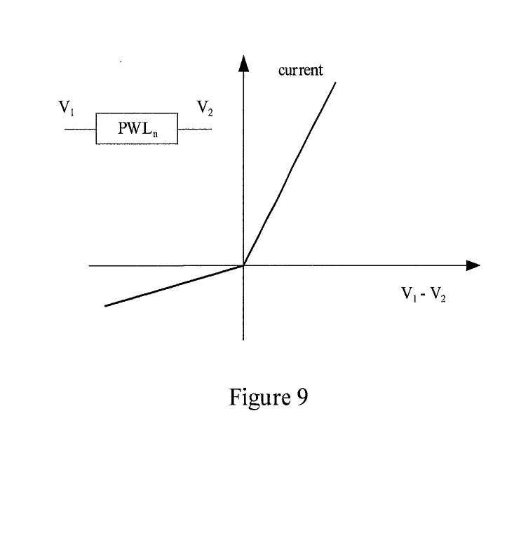

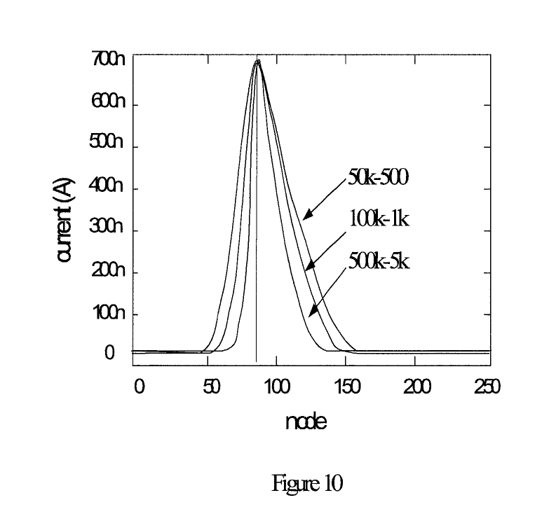

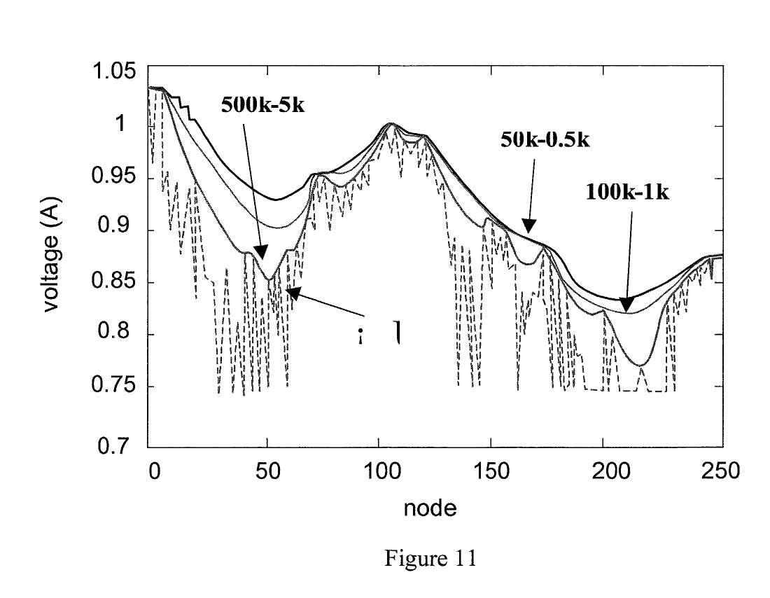

FIG. 8 illustrates an embodiment of a masking Winner-Take-All circuit 800 according to the present invention. Current sources Iₖ input current into nMOS transistor pairs T₁ₖ, T₂ₖ, producing transistor voltages Vₖ, and node voltages V_{Ck}. Piecewise linear resistors PWLₙ are coupled in series between the nodes 801, 802, 803, . . . which are coupled to diode-connected nMOS transistors T₃ₖ. Piecewise linear resistors PWLₙ produce a current versus differential voltage shown in FIG. 9, and generates the observed asymmetric inhibitory characteristics of the masking effect (see FIG. 1). Experiments conducted utilized a 256 cell (neuron/transistor pair) SPICE simulation. FIG. 10 is a graph of the current output of a masker according to the present invention generated by a simple tone input to neuron number 30 of 700nA and 100 nA to the other cells, wherein the observed mask effect asymmetry is achieved. Vowel spectrum inputs into the present invention produce winning spectral components (highest output currents) which not only inhibit neighboring spectral components, but also absorb neighbors' bias currents, thus increasing the “winners” own output currents and increasing formant extraction effectiveness. “Formants” are the defining characteristics (peaks in the sound spectrum) and thus the more pronounced, the better the speech recognition. Further, the components are clearly quantized, each being a harmonic of the fundamental frequency. Information for distinguishing different phonemes is carried in the envelope of a speech spectrum. The masking WTA system of the present invention further extracts spectrum envelopes from the inputted speech. Node voltage V_{Ck} in FIG. 8 exhibits a smoothed spectrum envelope of the input current Iₖ. If the neuron in question corresponds to a spectral valley, then the current output of that neuron will be inhibited by its neighboring peaks, but the node voltage will also increase (as mentioned above) so a smooth node voltage corresponding to the envelope of the input spectrum is achieved. FIG. 11 shows the envelope extraction produced by the present invention. The solid curves are node voltages corresponding to different PWL resistances (50 k-0.5 k, 100 k-1 k, and 500 k-5 k) and the dashed curve is where there are no resistances.

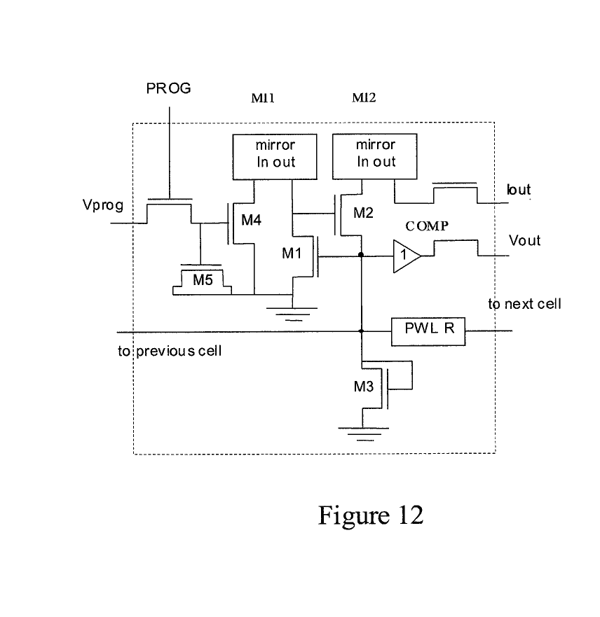

FIG. 12 is a conceptual schematic diagram of a single masking WTA cell according to an embodiment of the present invention, comprising three nMOS transistors M1, M2, and M3, a PWL R resistor, a voltage buffer, MOS capacitor M5 and two current mirrors MI1 and MI2. In the programming phase, an input voltage is stored at MOS capacitor M5; M4 converts the voltage to current for input through current mirror MI1. In operation, voltage output is buffered by a unity-gain buffer and then coupled to an output bus. Output current is copied by current mirror MI2 and transmitted to a current output bus. Output current is then converted to voltage by a linear grounded resistor PWL R. PWL R has resistance sensitive to current direction changes (FIG. 9), the perceptual masking curve (FIG. 1), and the ratio of the leftward resistance to rightward resistance is as large as 100. The two nMOS transistors M1 and M2 act as passive resistors for the two current flow directions with a comparator COMP switching between M1 and M2 depending on the sign of the voltage drop (the resistances being adjusted by the gate voltages). This embodiment of the present invention was implemented with supporting circuitry (for stability, signal gain, and leakage-avoidance) in a UMC™ 0.5 micron double-poly, double-metal CMOS process. The voltage outputs generate the spectrum envelope and the current outputs generate the spectrum formants. Utilizing the masking WTA circuit of the present invention, the formants of the vowel, “ai” are clearly visible in spectrograms even with the addition of noise in the input signal.

In the preferred embodiment of the masking WTA network of the present invention, an analog parallel processing system is advantageously utilized to integrate with the other components of an ASR system. For example, a band-pass filter bank is coupled to the upstream to provide input to the masking WTA network.

While the above is a full description of the specific embodiments, various modifications, alternative constructions and equivalents may be used. For example, although some of the examples shown were for Mandarin Chinese, the concepts described in the present invention are suitable for any language. Further, any implementation technique, either analog or digital, numerical or hardware processors, can be advantageously utilized. Therefore, the above description and illustrations should not be taken as limiting the scope of the present invention which is defined by the appended claims.

What is claimed is:

1. A perceptual speech processor comprising a noise masker for simulating the masking effect of a noise tone, said noise masker comprising:
a masking winner-take-all circuit including
a plurality of transistor pairs each pair being coupled to a current source and coupled in parallel to a bus;
a plurality of piecewise linear resistors, each corresponding to one of said plurality of transistor pairs, and coupled in series to said bus; and
a plurality of diode-coupled transistors, each coupled to a corresponding one of said plurality of paired transistors and coupled to said bus.

2. The perceptual speech processor of claim 1 wherein said plurality of piecewise linear resistors changes resistance responsive to a change in sign of voltage drop.

3. The perceptual speech processor of claim 1 wherein said plurality of piecewise linear resistors has a leftward to rightward current flow resistance in the range of 50-100.

4. A perceptual speech processor comprising a magnitude renormalizer for translating objective signal magnitude to a subjective loudness minimum audible field over the speech frequency domain.

5. A perceptual speech processor comprising a mel-scale frequency adjuster for adjusting the physical Hertz frequency of a signal to the perceptual mel-scale frequency of the same signal.

6. A perceptual speech processor comprising:
a noise masker for simulating the effect of a noise tone;
a magnitude renormalizer, coupled to said noise masker, for translating objective signal magnitude to a subjective loudness minimum audible field over the speech frequency domain; and
a mel-scale frequency translator, coupled to said magnitude renormalizer, for translating the physical Hertz frequency of a signal to the perceptual mel-scale frequency of the same signal, thereby generating a perceptual spectrum.

7. A method for recognizing a Fourier spectrum speech input signal comprising the steps of:
(a) removing the frequency components of the signal masked by louder neighboring components;
(b) renormalizing the magnitude of each frequency component of the signal according to a minimum amplitude field (MAF) curve; and
(c) translating each frequency component of the signal to mel-scale by resampling.

8. The method of claim 7 wherein step (a) comprises the steps of electronically simulating the masker to determine the masked frequencies to be removed.

9. The method of claim 8 wherein said electronic simulation utilizes a masking winner-take-all circuit having a plurality of piecewise linear resistors for modeling an asymmetric mask.

10. The method of claim 7 wherein step (b) comprises the step of renormalizing the magnitude of each frequency according to all of a plurality of equal loudness curves.

11. The method of claim 7 wherein step (c) comprises the step of calculating the mel-scale utilizing mel=2595×log(130 f/700) where f is the frequency.
